(19) United States
(12) Patent Application Publication
(10) Pub. No.: US 2020/0240091 A1
(43) Pub. Date: Jul. 30, 2020

(54) GRASS SURROGATE

(71) Applicants: Toyota Motor Engineering & Manufacturing North America, Inc., Plano, TX (US); The Trustees of Indiana University, Indianapolis, IN (US); Ohio State Innovation Foundation, Columbus, OH (US)

(72) Inventors: Rini Sherony, Ann Arbor, MI (US); Stanley Yung-Ping Chien, Zionsville, IN (US); Qiang Yi, Carmel, IN (US); Jun Lin, Carmel, IN (US); Abir Saha, Chicago, IL (US); Yaobin Chen, Carmel, IN (US); Chi-Chih Chen, Dublin, OH (US)

(21) Appl. No.: 16/256,412

(22) Filed: Jan. 24, 2019

(51) Int. Cl. E01C 13/08; G01M 17/007; A41G 1/00

(52) U.S. Cl. CPC E01C 13/08; A41G 1/009; G01M 17/007

(57) ABSTRACT

Surrogates for roadside objects can be used for vehicle testing. A grass surrogate can be configured to exhibit substantially the same characteristics as natural grass when sensed by one or more vehicle sensors (e.g., cameras, radar sensors, and/or LIDAR sensors). Such surrogates can be used to test autonomous vehicles, one or more vehicle sensors, a vehicle sensor system, and/or one or more vehicle systems (e.g., a road departure mitigation system). The grass surrogate can help a vehicle to identify road boundaries, particularly in portions of a road that do not include lane markings. The grass surrogate can be configured to withstand being driven over by a test vehicle without being damaged and/or without damaging the test vehicle. In some arrangements, the grass surrogate can include artificial grass that is coated with a mixture of high gloss acrylic paint and high reflectance pigments.

### FIELD

The subject matter described herein relates in general to vehicles and, more particularly, to the testing of vehicle systems.

### BACKGROUND

When a vehicle departs from a road, the situation can quickly become extremely dangerous. For instance, there are various roadside objects that a vehicle can collide with, and/or the vehicle may be prone to rollover on grass. Some vehicles are equipped with a road departure mitigation system, and it is expected that the use of such systems will increase in the future. A road departure mitigation system can detect when a vehicle is about to leave the road. In such case, the road departure mitigation system can provide a warning to the driver and/or can automatically control one or more vehicle systems (e.g., steering and/or braking) to prevent the vehicle from departing the road.

### SUMMARY

In one respect, the subject matter described herein is directed to a grass surrogate. The grass surrogate can include a plurality of grass blades. The grass blades can include a blade body and a coating that covers at least a portion of the blade body. The blade body can be made of a synthetic material. The grass surrogate can be configured to exhibit substantially the same characteristics as a natural grass relative to one or more vehicle sensors.

In another respect, the subject matter described herein is directed to a grass surrogate. The grass surrogate can include a base and a plurality of grass blades operatively connected to the base. A substantial majority of the plurality of grass blades can be oriented at an acute angle relative to the base. The grass blades can include a blade body and a coating. The coating can cover at least a portion of the blade body. The blade body can be made of a synthetic material. The coating can include a mixture of high gloss acrylic paint and high reflectance pigments. The grass surrogate can be configured to exhibit substantially the same characteristics as a natural grass relative to one or more vehicle sensors.

In still another respect, the subject matter described herein is directed to a vehicle testing environment, such as a test track or a testing facility. The vehicle testing environment can include a road. The vehicle testing environment can include a grass surrogate provided on a side of the road. The grass surrogate can include a plurality of grass blades. The grass blades can include a blade body and a coating. The coating can cover at least a portion of the blade body. The blade body can be made of a synthetic material. The grass surrogate can be configured to exhibit substantially the same characteristics as a natural grass relative to one or more vehicle sensors.

### BRIEF DESCRIPTION OF THE DRAWINGS

FIG. 1 is a view of an example of a grass surrogate.

FIG. 2 is a cross-sectional view of a portion of a grass blade of a grass surrogate, showing the grass blade being sensed by one or more sensors.

FIG. 3 is a view of a portion of a grass surrogate, showing a plurality of grass blades oriented at an angle relative to a base.

FIG. 4 is a view of an example of a vehicle testing environment.

FIG. 5 is a table of various example paint colors for a coating of the grass surrogate.

FIG. 6 is a table showing various examples of paint and pigment mixtures for a coating of the grass surrogate.

FIGS. 7A-H show examples of infrared reflectance requirements of the grass surrogate at various detection angles.

FIGS. 8A-H show the infrared reflectance of grass surrogates at various detection angles.

FIGS. 9A-F show examples of a suggested radar cross section at 77 GHz at various detection angles.

FIG. 10A shows the 77 GHz radar cross section of natural grass at a 10 degree detection angle.

FIG. 10B shows the 77 GHz radar cross section of a grass surrogate on asphalt at a 10 degree detection angle.

FIG. 11A shows the 77 GHz radar cross section of natural grass at a 10 degree detection angle.

FIG. 11B shows the 77 GHz radar cross section of a grass surrogate on asphalt at a 15 degree detection angle.

### DETAILED DESCRIPTION

According to arrangements herein, surrogates are provided for one or more roadside objects, such as grass. These surrogates can approximate the overall visual appearance of the corresponding roadside object, and they can exhibit substantially the same characteristics to one or more vehicle sensors (e.g., cameras, radar sensors, LIDAR sensors, etc.) as their corresponding roadside objects. For example, the surrogates can have substantially the same visual appearance (e.g., color, size, and shape) as the corresponding roadside object. In this respect, the surrogate can appear substantially same to vehicle cameras as the actual corresponding roadside object. Further, the surrogates can exhibit substantially the same radar reflectivity and/or radar cross-section as the corresponding roadside object. Thus, the surrogate can appear substantially the same to a radar sensor as the corresponding roadside object. Still further, the surrogates can exhibit substantially the same infrared reflectivity as the corresponding roadside object. The surrogate can appear substantially the same to a LIDAR sensor as the corresponding roadside object. In one or more arrangements, for a grass surrogate, the radar cross-section (RCS) of the grass surrogate can be ±5 dB of the mean RCS of natural grass for both 24 GHz and 77 GHz radar.

These surrogates can be used in the testing of vehicles, such as autonomous vehicles and/or vehicles with a road departure mitigation system. The surrogates can be configured to be driven over by a test vehicle without damaging the test vehicle. The surrogates can also be configured to be driven over by a vehicle without damaging the surrogate in many cases.

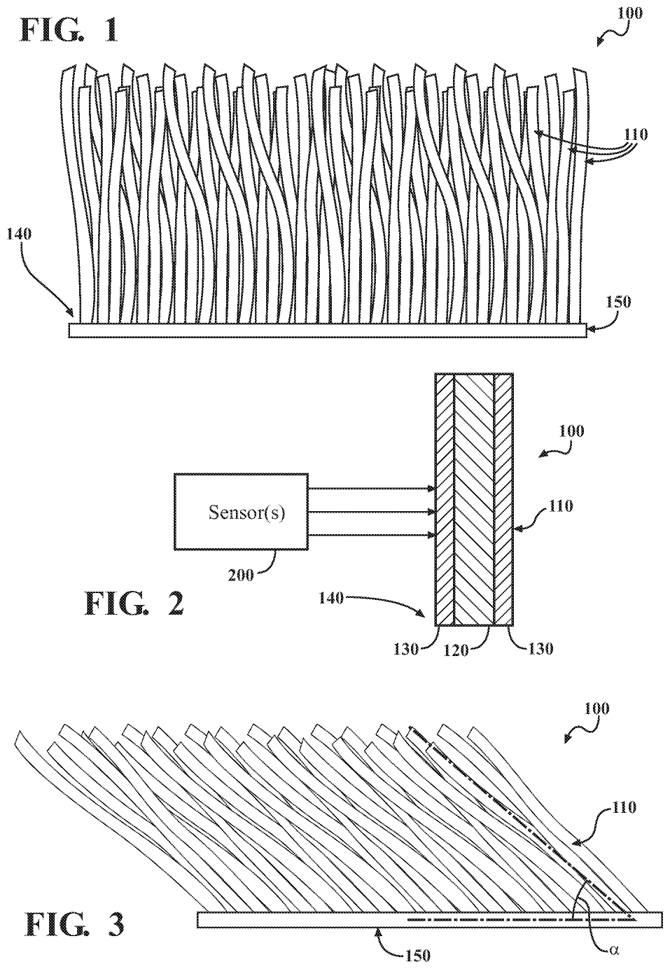

Detailed embodiments are disclosed herein; however, it is to be understood that the disclosed embodiments are intended only as exemplary. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of embodiments and aspects herein. Various arrangements are shown in FIGS. 1-11, but they are not limited to the illustrated structure(s) or application(s).

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features. In addition, numerous specific details are set forth in order to provide a thorough understanding of the embodiments described herein. However, it will be understood by those of ordinary skill in the art that the embodiments described herein can be practiced without these specific details.

As used herein, the terms “substantially” and “about” include exactly the term they modify and slight variations therefrom. Thus, the term “substantially vertically” means exactly vertically and slight variations therefrom. Slight variations therefrom can include being within normal manufacturing tolerance, within 15 degrees/percent/units or less, 10 degrees/percent/units or less, 9 degrees/percent/units or less, 8 degrees/percent/units or less, 7 degrees/percent/units or less, 6 degrees/percent/units or less, 5 degrees/percent/units or less, 4 degrees/percent/units or less, 3 degrees/percent/units or less, 2 degrees/percent/units or less, 1 degree/percent/unit or less.

One example of a roadside object in which arrangements described herein can be used is grass. Grass is found along roads throughout the world.

In one or more arrangements, a surrogate for grass can be provided. Examples of a grass surrogate 100 is shown in FIGS. 1-4. The grass surrogate 100 can have substantially the same size, shape, and/or configuration as grass, which can be any type of grass now known or later discovered or developed. The grass surrogate can be configured to exhibit substantially the same characteristics as a natural grass relative to one or more vehicle sensors (e.g., a camera sensor, a LIDAR sensor, or a radar sensor). “Natural grass” refers to any living grass, now known or later discovered or developed.

Referring to FIG. 1, the grass surrogate 100 can include a plurality of grass blades 110 operatively connected to a base 150 in any suitable manner, including for, example, by one or more adhesives, one or more forms of bonding, one or more forms of stitching, one or more forms of weaving, and/or one or more forms of mechanical engagement. The term “operatively connected,” as used throughout this description, can include direct or indirect connections, including connections without direct physical contact. The grass blades 110 and the base 150 may be in the nature of any synthetic grass, artificial grass, or artificial turf, now known or later developed. The grass blades 110 can be made of any suitable material. For instance, the grass blades 110 can be made of polyethylene, rubber, or nylon. The grass blades 110 can be substantially straight. Alternatively, the grass blades 110 can be bowed, wavy, or otherwise non-straight.

The plurality of grass blades 110 have substantially the same size and shape as grass blades of natural grass. The grass blades 110 can be made in a variety of sizes (e.g., length, width, height, etc.) to match their natural grass counterpart. The grass blades 110 can have a length. In one or more arrangements, the grass blades 110 can have a length of substantially 2.25 inches. The grass blades 110 can have any suitable width. In one or more arrangements, the grass blades 110 can have a width of substantially 2 inches. The grass blades 110 can be provided at any suitable density. For example, in one or more arrangements, the plurality of grass blades have a density of about 50 ounces per square yard to about 80 ounces per square yard. More particularly, the plurality of grass blades have a density of about 65 ounces per square yard to about 70 ounces per square yard.

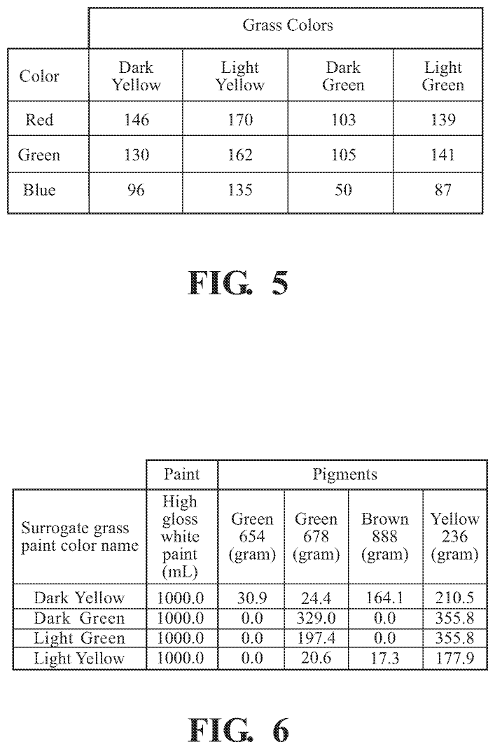

An example of a cross-sectional view of a portion of one of the grass blades 110 is shown in FIG. 2. The grass blade 110 can include a blade body 120. The blade body 120 can be at least partially covered by a coating 130. In some instances, a root 140 of the grass blades 110 can be at least partially covered by the coating 130. The coating 130 can be any suitable coating that can help to cause the grass surrogate 100 to exhibit substantially the same characteristics as natural grass relative to one or more vehicle sensors (e.g., LIDAR sensors, radar sensors, cameras). In one or more arrangements, the coating 130 can include a mixture of paint and pigments. As an example, the paint can be acrylic paint and, more particularly, high gloss acrylic paint. The pigments can be high reflectance pigments. There can be any suitable paint to pigment ratio in the coating 130. Non-limiting examples of various paint and pigment mixtures for the coating 130 are shown in FIG. 6.

The grass surrogate 100 can be any color needed to simulate natural grass. For instance, the grass surrogate 100 can have a color that mimics living grass. As another example, the grass surrogate 100 can have a color that mimics dead grass. As a further example, the grass surrogate 100 can be the color of both living grass and dead grass. Some examples of colors that the grass surrogate 100 can be include green, brown, yellow, combinations thereof, and any and all variations of color properties (e.g., hue, tint, shade, saturation, brightness, chroma, intensity, brightness, etc.) of those colors. The color of the grass surrogate 100 can be attained by the color of the blade body 120 and/or the color of the coating 130. Non-limiting examples of various paint colors for surrogate grass are shown in FIG. 5.

The grass blades 110 can have any suitable orientation relative to the base 150. Referring to FIG. 3, an angle α can be defined between the grass blades 110 and the base 150. In one or more arrangements, a majority of the grass blades 110 can be angled at an acute angle relative to the base 150. In one or more arrangements, a substantial majority of the grass blades 110 can be angled at an acute angle relative to the base 150. In one or more arrangements, the angle α can be about 85 degrees or less, about 80 degrees or less, about 75 degrees or less, about 70 degrees or less, about 65 degrees or less, about 60 degrees or less, about 55 degrees or less, about 50 degrees or less, about 45 degrees or less, about 40 degrees or less, about 35 degrees or less, about 30 degrees or less, about 25 degrees or less, about 20 degrees or less, about 15 degrees or less, or about 10 degrees or less. As used herein, “majority” means 50.01 percent or greater. As used herein, “substantial majority” means 70 percent or greater, 75 percent or greater, 80 percent or greater, 85 percent or greater, 90 percent or greater, 95 percent or greater, 96 percent or greater, 97 percent or greater, 98 percent or greater, or 99 percent or greater. In some instances, the angle α can be achieved, at least in part, by the manner in which the coating 130 is applied to the grass blades 110. In one or more arrangements, a majority of the grass blades 110 can extend in substantially the same direction relative to the base 150 or some other reference point. In one or more arrangements, a substantial majority of the grass blades 110 can extend in the same direction relative to the base 150 or some other reference point.

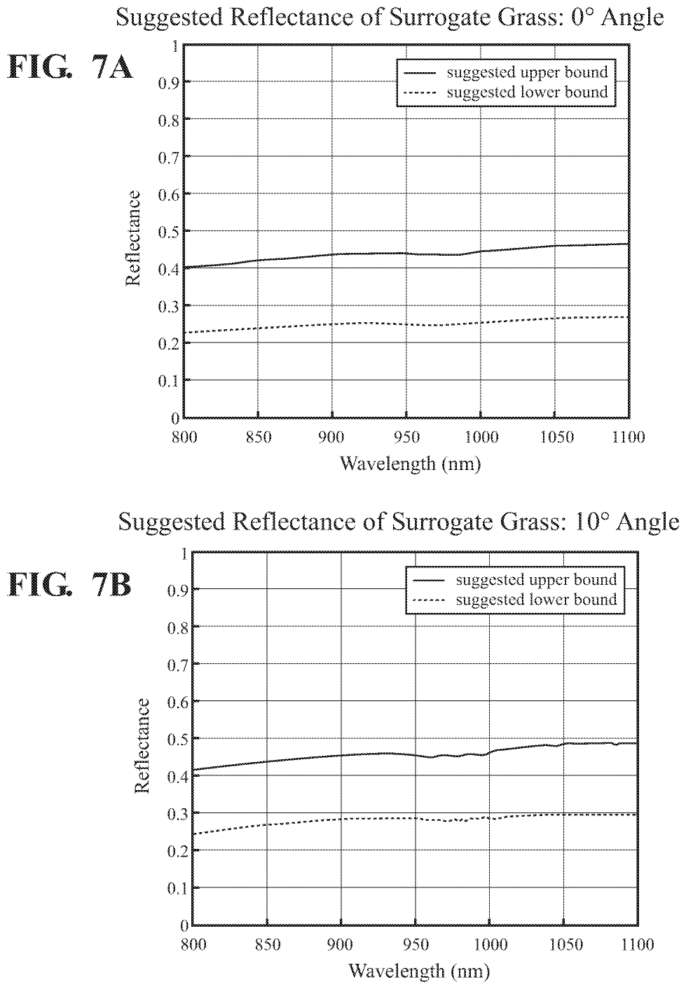

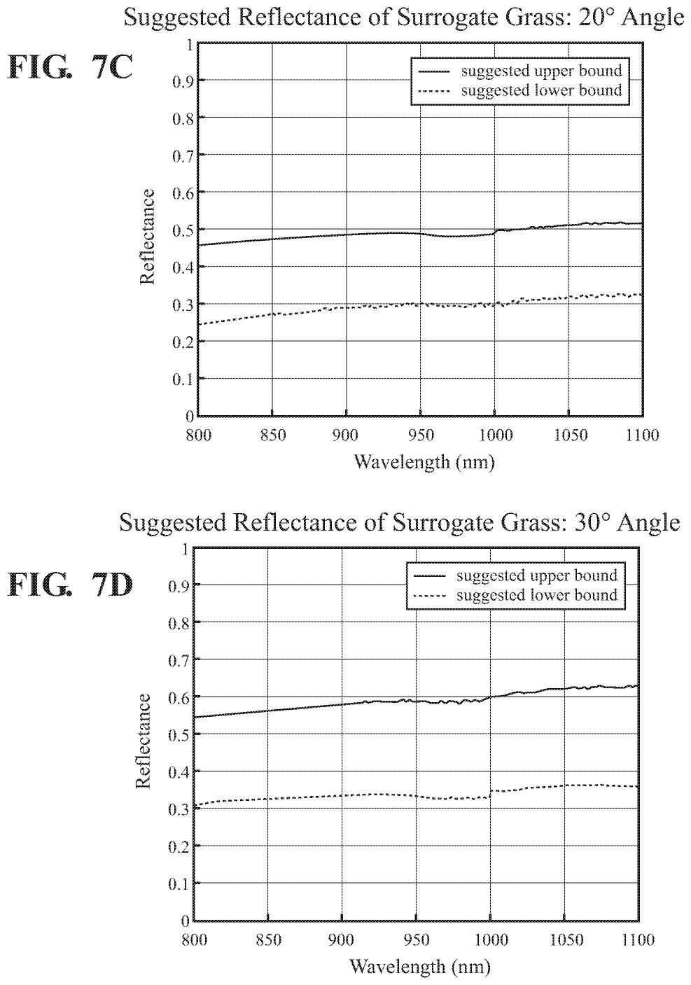

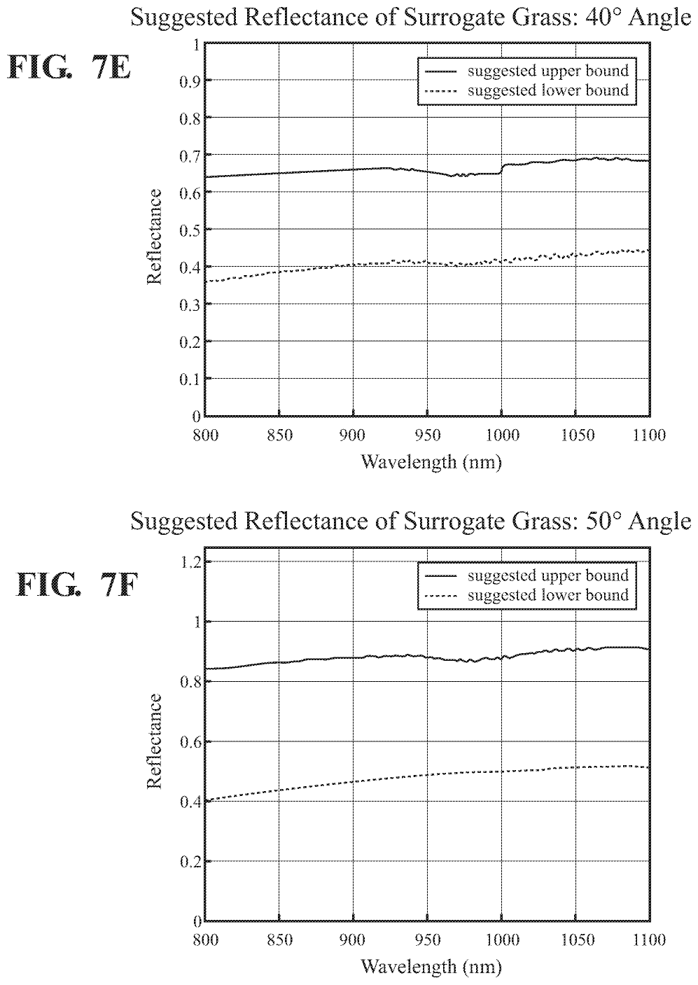

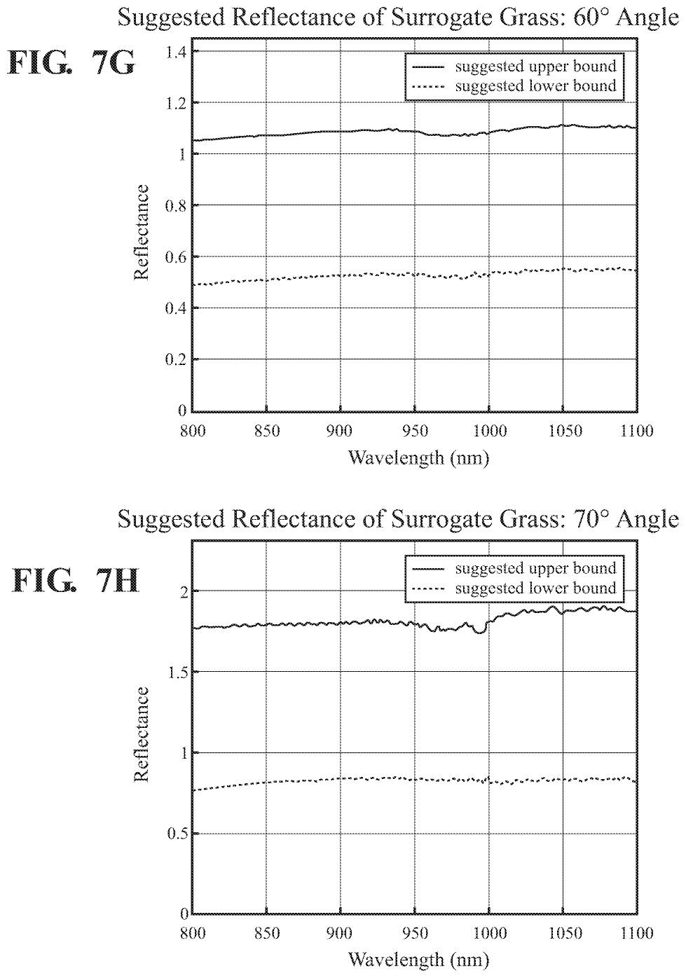

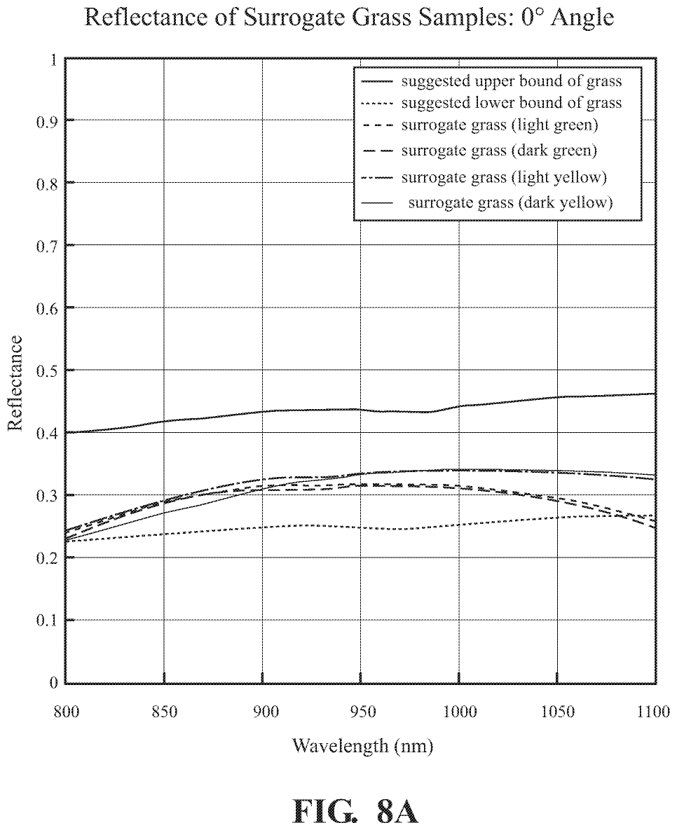

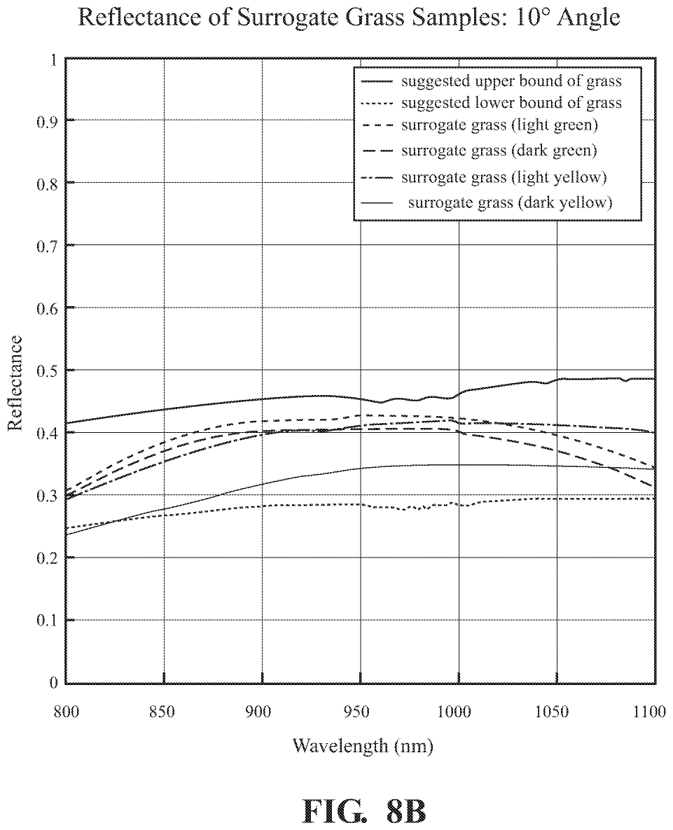

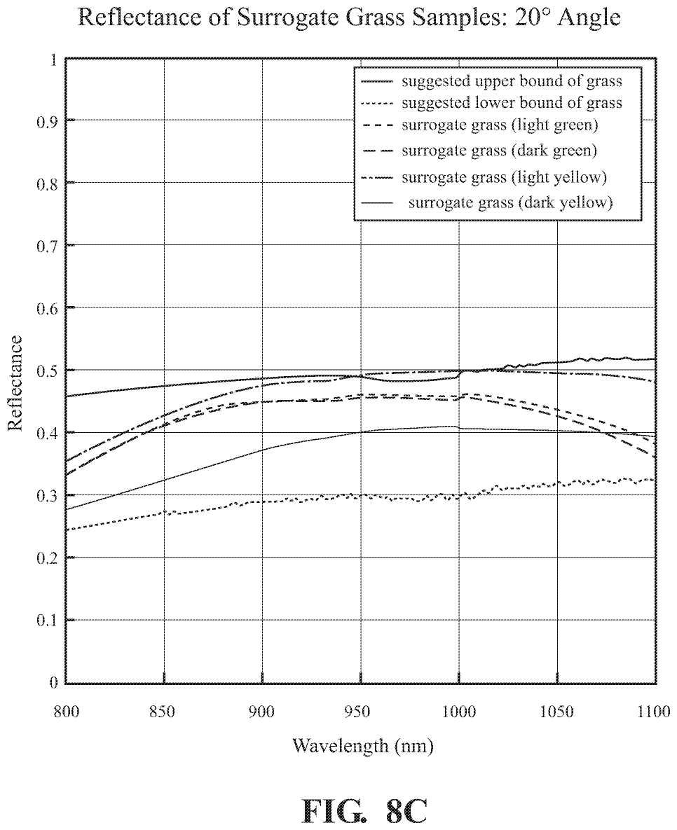

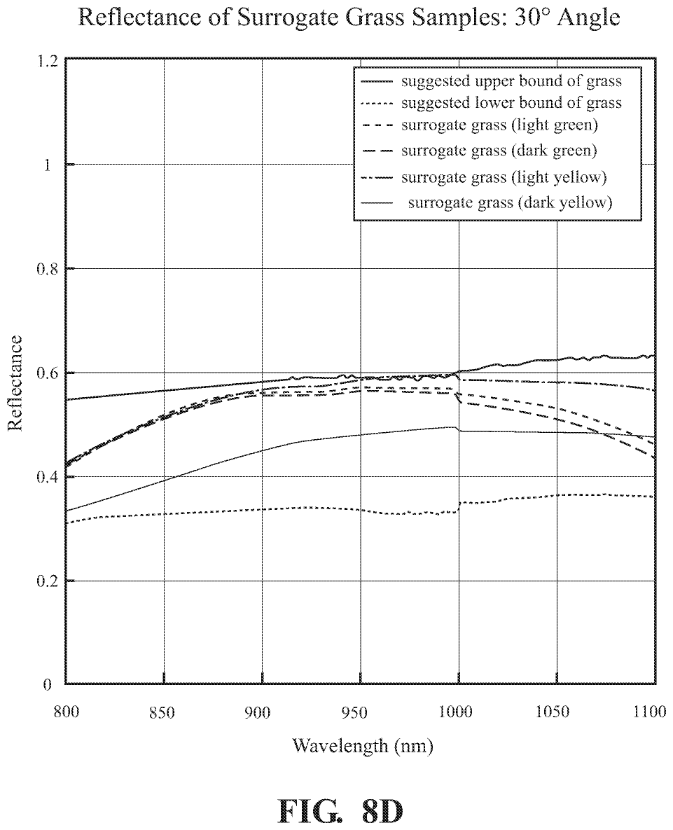

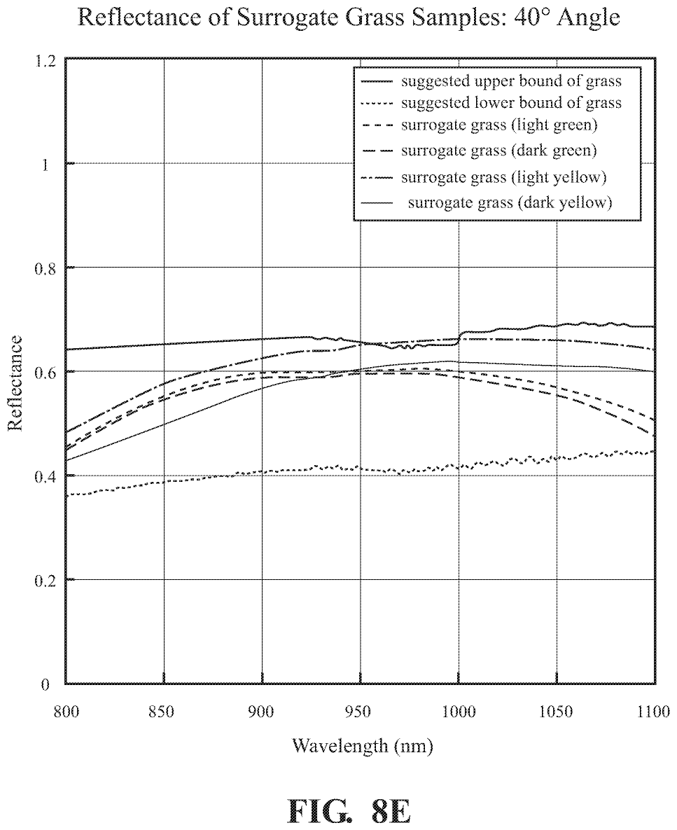

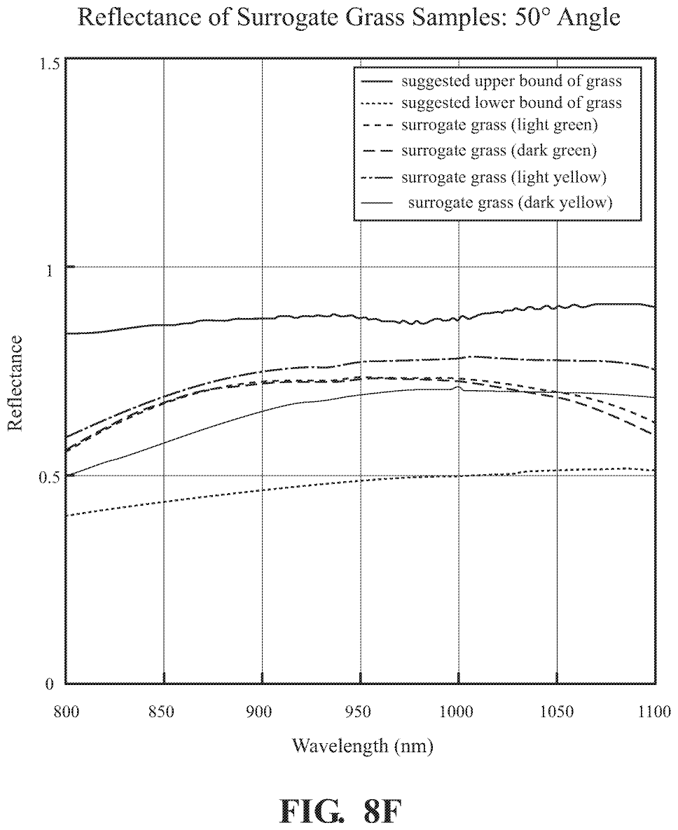

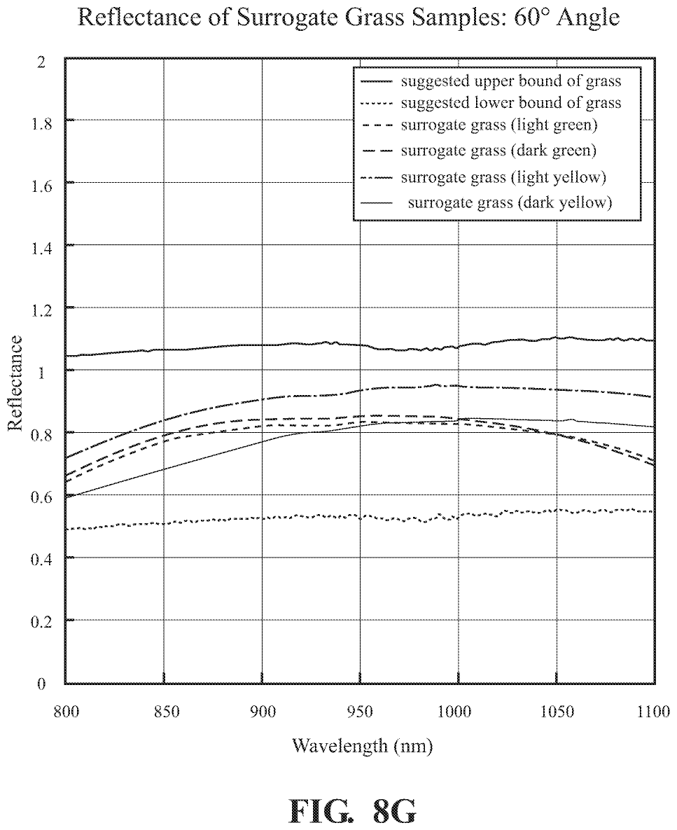

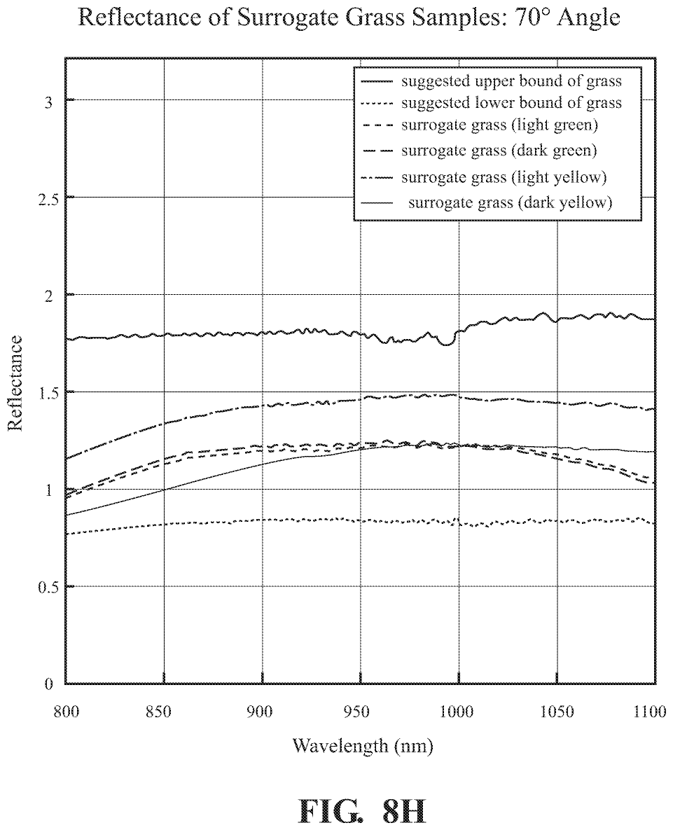

Examples of infrared reflectance requirements of the grass surrogate 100 at various detection angles are shown in FIGS. 7A-H. Test data showed that various sample grass surrogates substantially met these infrared requirements in the detection angle range of 0 to 70 degrees, as is shown in FIGS. 8A-H.

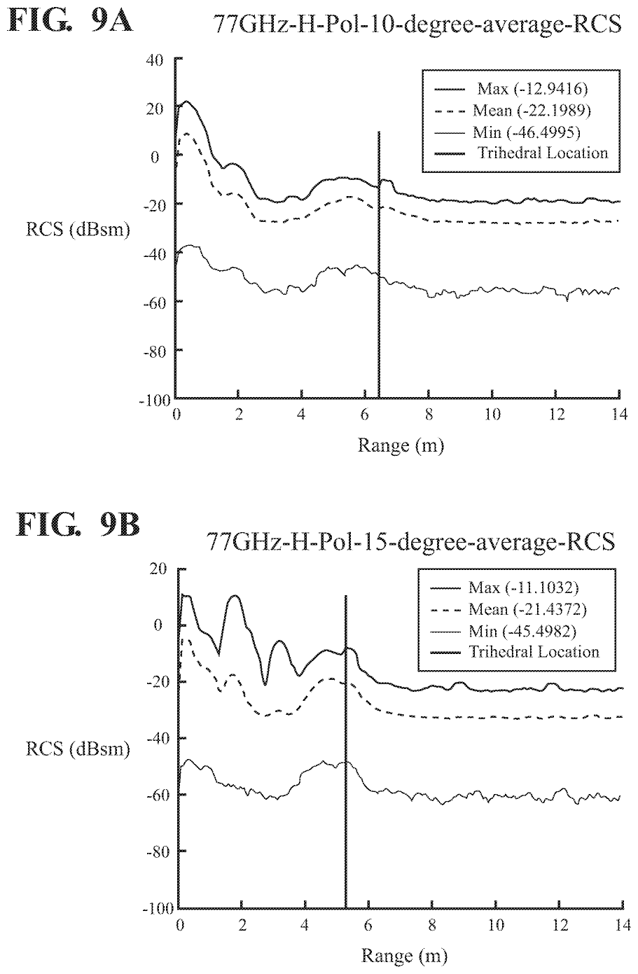

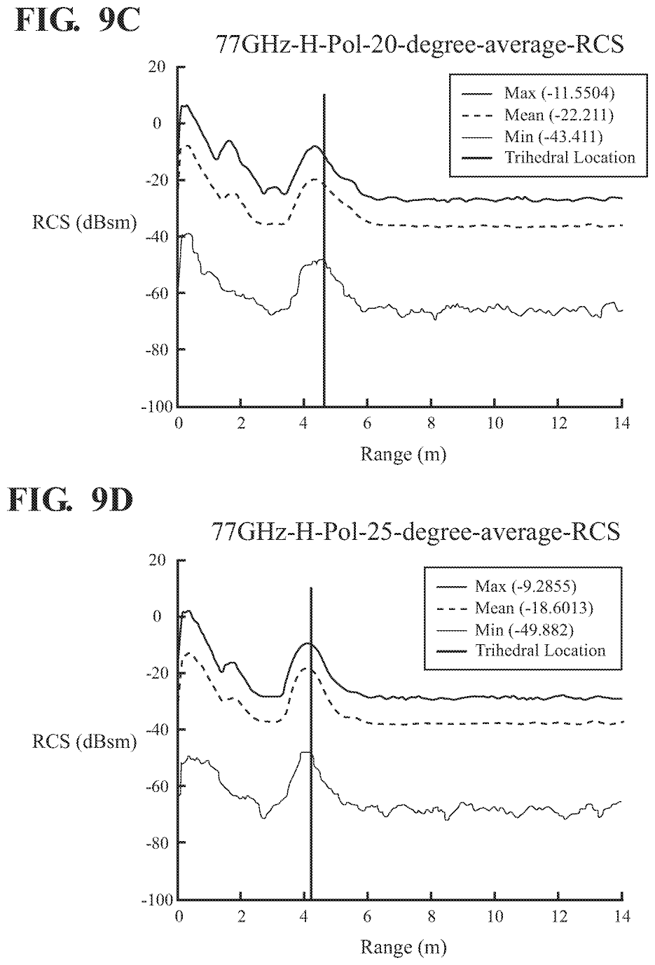

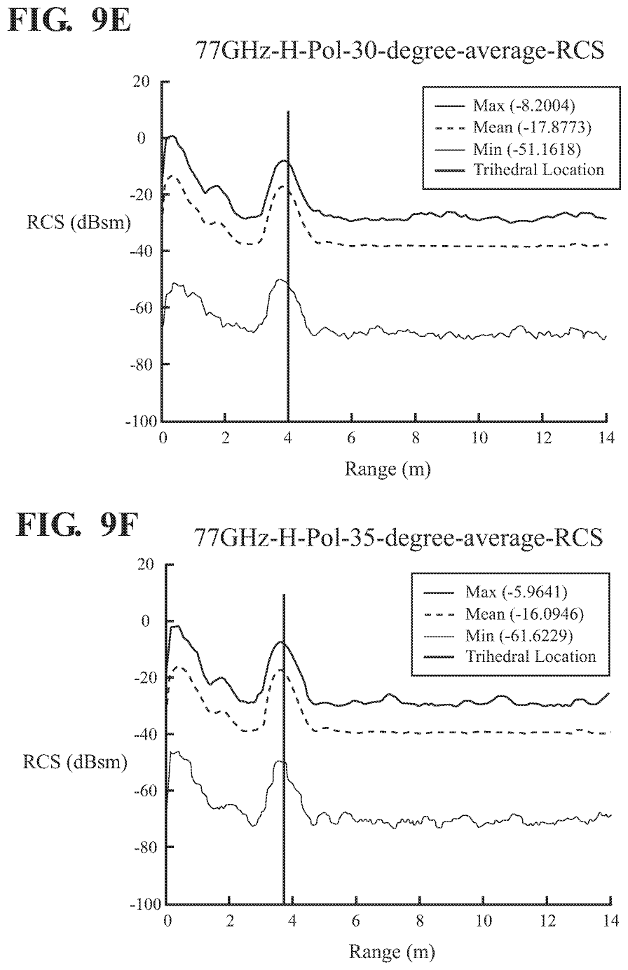

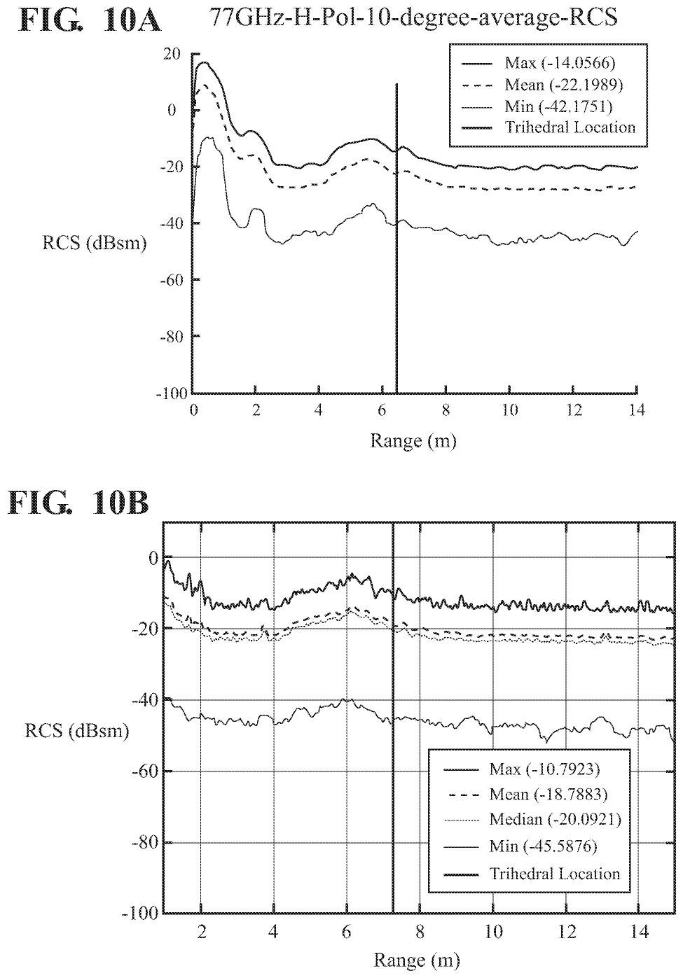

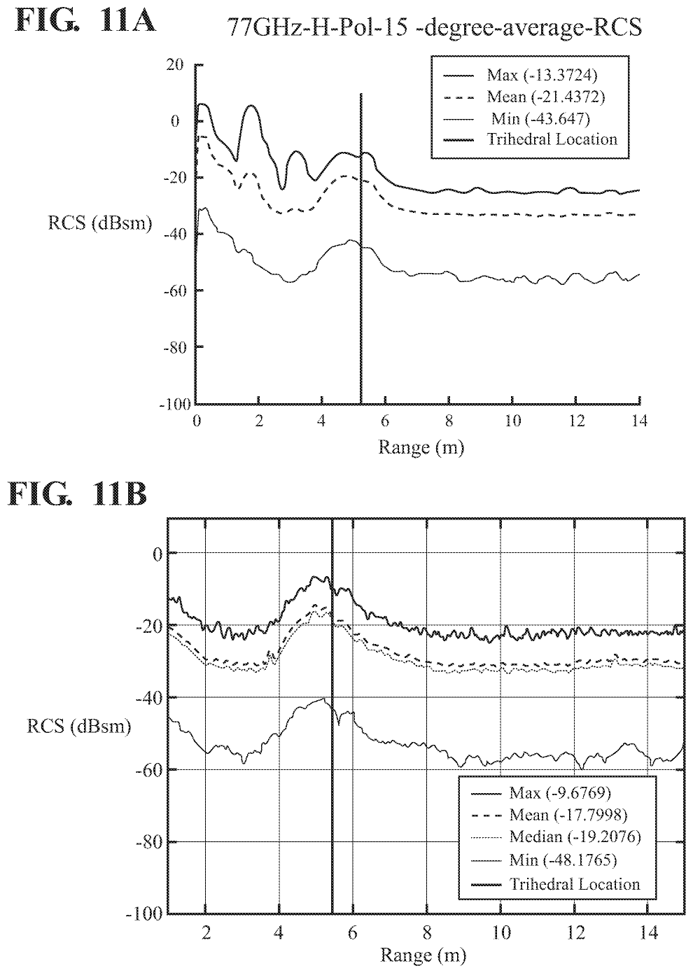

Examples of radar cross section (RCS) requirements for the grass surrogate 100 at 77 GHz and at various detection angles are shown in FIGS. 9A-F. Test data showed that the sample grass surrogates substantially met radar cross section (RCS) requirements (e.g., ±5 dB of the mean RCS of natural grass for both 24 GHz and 77 GHz radar). For instance, FIG. 10A shows the 77 GHz radar cross section of natural grass at a 10 degree detection angle, and FIG. 10B shows the 77 GHz radar cross section of a grass surrogate on asphalt at a 10 degree detection angle. As another example, FIG. 11A shows the 77 GHz radar cross section of natural grass at a 10 degree detection angle, and FIG. 11B shows the 77 GHz radar cross section of a grass surrogate on asphalt at a 15 degree detection angle.

The grass surrogate 100 described herein can be used for various purposes. For instance, the grass surrogate 100 can be used in connection with the testing of vehicles. A vehicle can have one or more sensors 200 (FIG. 2). “Sensor” means any device, component and/or system that can acquire, detect, determine, assess, monitor, measure, quantify, and/or sense something. The one or more sensors 200 can acquire, detect, determine, assess, monitor, measure, quantify, and/or sense in real-time. As used herein, the term “real-time” means a level of processing responsiveness that a user or system senses as sufficiently immediate for a particular process or determination to be made, or that enables the processor to keep up with some external process.

In arrangements in which the vehicle includes a plurality of sensors 200, the sensors 200 can work independently from each other. Alternatively, two or more of the sensors 200 can work in combination with each other. In such case, the two or more sensors 200 can form a sensor network. The one or more sensors 200 can be operatively connected to processor(s), the data store(s), and/or other elements or systems of the vehicle.

The one or more sensors 200 can include one or more environment sensors configured to acquire, detect, determine, assess, monitor, measure, quantify, and/or sense driving environment data. “Driving environment data” includes and data or information about the external environment in which a vehicle is located or one or more portions thereof. For example, the one or more environment sensors can acquire data or information about obstacles in at least a portion of the external environment of the vehicle. In one or more arrangements, the one or more sensors 200 can include one or more radar sensors, one or more LIDAR sensors, and/or one or more cameras.

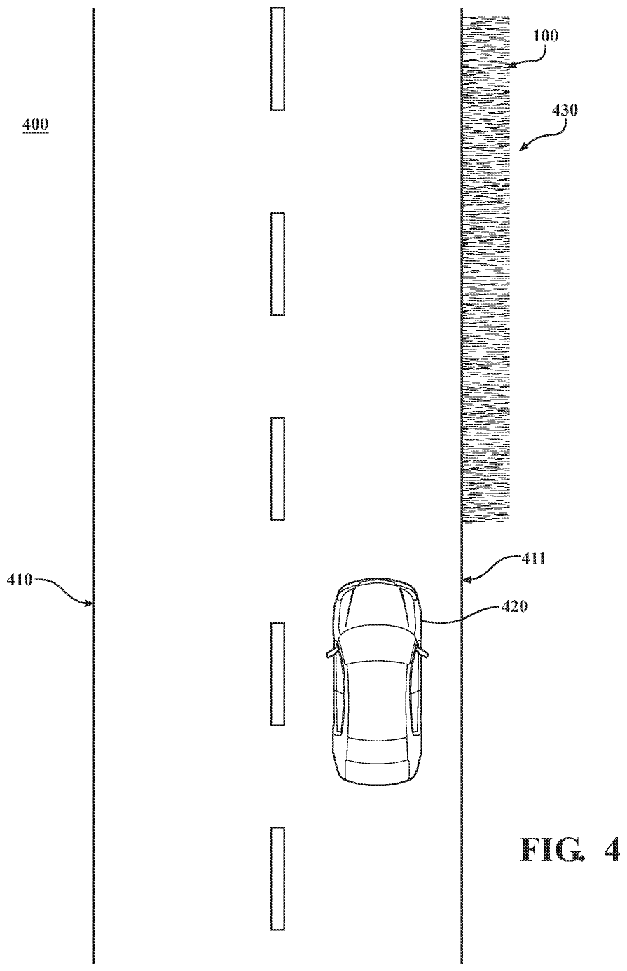

The grass surrogate 100 can be used in a vehicle testing environment 400, as is shown in FIG. 4. The vehicle testing environment 400 can be, for example, a test track or a testing facility. The vehicle testing environment 400 can include a road 410 on which a test vehicle 420 can be driven, autonomously, semi-autonomously, and/or manually. The grass surrogate 100 can be set up in an appropriate position with respect to the road 410. For example, the grass surrogate 100 can be substantially adjacent to the road 410. For instance, the grass surrogate 100 can be placed at an edge 411 of the road 410. In such case, the grass surrogate 100 may define at least a portion of the edge 411 of the road 410 in that location. Alternatively or in addition, the edge 411 of the road 410 may be defined by road markings. In some instances, the grass surrogate 100 can be laterally spaced from the edge 411 of the road 410.

While FIG. 4 show the grass surrogate 100 as being used on one side of the road 410, it will be understood that the grass surrogate 100 can be used on one or both sides of the road 410. The grass surrogate(s) 100 used on one side of a road can be substantially identical to the grass surrogate(s) 100 used on the other side of the road, or they can be substantially mirror images of each other.

In some arrangements, one continuous grass surrogate 100 can be used on a side of the road 410, as is shown in FIG. 4. Alternatively, there can be a plurality of grass surrogates 100 on the side of the road 410. The plurality of grass surrogates can be substantially identical to each other. Alternatively, one or more of the plurality of grass surrogates can be different from the other grass surrogates in one or more respects, including in any respect described herein.

The plurality of grass surrogates can be arranged in any suitable manner. For instances, the grass surrogates can be substantially aligned with each other. Alternatively, one or more of the grass surrogates can be offset from the other grass surrogates. The grass surrogates 100 can be arranged to be substantially adjacent to each other, or they can be spaced from each other. In some or more arrangements, the plurality of grass surrogates can be arranged in an end to end manner such that the grass surrogates abut each other. In some instances, two or more of the grass surrogates 100 can be operatively connected to each other in any suitable manner, including, for example, one or more adhesives, one or more forms of mechanical engagement, and/or one or more fasteners.

In arrangements in which the grass blades 110 of the grass surrogate 100 are oriented at an acute angle relative to the base 150, the grass surrogate 100 can be positioned such that the grass blades 110 lean away from the road 410. More particularly, the grass surrogate 100 can be positioned such that the grass blades 110 lean away from the road 410 in a direction that is substantially 90 degrees relative to the travel direction and/or the longitudinal axis of the road 410. In other arrangements, the grass surrogate 100 can be positioned such that the grass blades 110 lean in a direction that is substantially parallel to the travel direction of the road 410 and/or the longitudinal axis of the road 410. More particularly, the grass surrogate 100 can be positioned such that the grass blades 110 lean in the travel direction of the road 410. Thus, the grass blades 110 that are located along the road 410 but ahead of a vehicle traveling in the travel direction on the road 410 will lean away from the vehicle.

The grass surrogate 100 can be positioned on a surface 430 in the vehicle test environment 400. In some instances, the type of surface can affect how the grass surrogate 100 is perceived by the one or more sensors 200 of the test vehicle 420. Thus, the surface 430 can be selected, configured, and/or provided to ensure that the grass surrogate 100 meets vehicle sensor requirements. In one or more arrangements, the surface 430 can be an asphalt surface.

During testing, the test vehicle 420 can move along the road 410. One or more sensors 200 of the test vehicle 420 can acquire driving environment data, including data about the grass surrogate 100. For instance, the test vehicle 420 can acquire data about the grass surrogate 100 using camera(s), radar sensor(s), and/or LIDAR sensor(s). Due to the construction of the grass surrogate 100, the data of the grass surrogate 100 acquired by the sensor(s) 200 can mimic the sensor data that would be acquired by the sensor(s) 200 of natural grass in a real world driving environment. The acquired driving environment data can be processed and/or analyzed, such as by one or more processors, to determine an appropriate action.

If the test vehicle 420 veers off of the road 410 and onto the grass surrogate 100, damage to the test vehicle 420 and/or the grass surrogate 100 can be avoided and/or minimized. Thus, the grass surrogate 100 can continue to be used in future tests. The grass surrogate 100 can help the test vehicle 420 to distinguish the boundaries of the road 410, particularly in those portions of the road 410 that do not include lane markings.

As an example, the surrogates described herein can be used in connection with the testing of the sensors and/or systems of an autonomous vehicle. “Autonomous vehicle” means a vehicle that configured to operate in an autonomous operational mode in which one or more computing systems are used to navigate and/or maneuver the vehicle along a travel route with minimal or no input from a human driver. In one or more arrangements, the autonomous vehicle can be highly automated or completely automated. As another example, the surrogates described herein can be used to road departure mitigation systems of non-autonomous vehicles.

It will be appreciated that arrangements described herein can provide numerous benefits, including one or more of the benefits mentioned herein. For example, arrangements described herein can provide surrogates that appear to be visually realistic to their counterpart roadside objects. Arrangements described herein can provide surrogates that mimic their corresponding roadside object with respect to one or more sensors. Arrangements described herein can result in a grass surrogate that generates the color, patterns, infrared and radar properties of natural grass. Arrangements described here enable the surrogates to be used in vehicle testing, particularly the testing of road departure systems. Arrangements described herein can be driven over during testing, thereby avoiding damage to the surrogates and/or to the test vehicle. Arrangements described herein can be used for internal testing and to support upcoming European New Car Assessment Programme (EUNCAP) requirements for road departure systems and potential future National Highway Traffic Safety Administration (NHTSA)/Insurance Institute for Highway Safety (IIHS) requirements. It will be appreciated that the grass surrogates according to arrangements described herein do not require the time and expense of upkeep (e.g., watering, cutting, fertilizing, etc.) compared to using natural grass. Unlike the natural grass that can be deformed/damaged when run over by the test vehicle, the grass surrogate can keep its shape after being run over many times.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects described herein can be embodied in other forms and combinations without departing from the spirit or essential attributes thereof. Thus, it will of course be understood that embodiments are not limited to the specific details described herein, which are given by way of example only, and that various modifications and alterations are possible.

What is claimed is:

1. A grass surrogate comprising:
a plurality of grass blades, the grass blades including a blade body and a coating covering at least a portion of the blade body, the blade body being made of a synthetic material,
the grass surrogate being configured to exhibit substantially the same characteristics as a natural grass relative to one or more vehicle sensors.

2. The grass surrogate of claim 1, further including a base, wherein the plurality of grass blades are operatively connected to the base, wherein, a substantial majority of the plurality of grass blades are angled at an acute angle relative to the base.

3. The grass surrogate of claim 1, wherein the plurality of grass blades have substantially the same size or shape as a plurality of natural grass blades.

4. The grass surrogate of claim 1, wherein the one or more vehicle sensors include a camera sensor, a LIDAR sensor, or a radar sensor.

5. The grass surrogate of claim 1, wherein the blade body is made of polyethylene, rubber, or nylon.

6. The grass surrogate of claim 1, wherein the coating includes a mixture of paint and pigments.

7. The grass surrogate of claim 6, wherein the coating includes a mixture of high gloss acrylic paint and high reflectance pigments.

8. The grass surrogate of claim 1, wherein the grass surrogate has a color that mimics living grass or a combination of living and dead grass.

9. The grass surrogate of claim 1, wherein the plurality of grass blades have a density of about 50 ounces per square yard to about 80 ounces per square yard.

10. The grass surrogate of claim 1, wherein the plurality of grass blades include a root, and wherein the coating covers at least a portion of the root.

11. A grass surrogate comprising:
a base; and
a plurality of grass blades operatively connected to the base, a substantial majority of the plurality of grass blades are angled at an acute angle relative to the base, the grass blades including a blade body and a coating covering at least a portion of the blade body, the blade body being made of a synthetic material, the coating includes a mixture of high gloss acrylic paint and high reflectance pigments, the grass surrogate being configured to exhibit substantially the same characteristics as a natural grass relative to one or more vehicle sensors.

12. The grass surrogate of claim 11, wherein the one or more vehicle sensors include a camera sensor, a LIDAR sensor, or a radar sensor.

13. The grass surrogate of claim 11, wherein the blade body is made of polyethylene, rubber, or nylon.

14. The grass surrogate of claim 11, wherein the grass surrogate has a color that mimics living grass or a combination of living and dead grass.

15. A vehicle testing environment comprising:
a road; and
a grass surrogate provided on a side of the road, the grass surrogate including a plurality of grass blades, the grass blades including a blade body and a coating covering at least a portion of the blade body, the blade body being made of a synthetic material, the grass surrogate being configured to exhibit substantially the same characteristics as a natural grass relative to one or more vehicle sensors.

16. The vehicle testing environment of claim 15, wherein the grass surrogate further including a base, wherein the plurality of grass blades are operatively connected to the base, and wherein, a substantial majority of the plurality of grass blades are angled at an acute angle relative to the base.

17. The vehicle testing environment of claim 16, wherein the grass surrogate is positioned such that the plurality of grass blades lean away from the road.

18. The vehicle testing environment of claim 16, wherein the grass surrogate is supported on an asphalt surface.

19. The vehicle testing environment of claim 15, wherein the blade body is made of polyethylene, rubber, or nylon.

20. The vehicle testing environment of claim 15, wherein the coating includes a mixture of high gloss acrylic paint and high reflectance pigments.
